(19) United States
(12) Patent Application Publication
(10) Pub. No.: US 2022/0184872 A1
(43) Pub. Date: Jun. 16, 2022

(54) EXTRUSION MOLDING APPARATUS AND ITS CONTROL METHOD

(71) Applicant: THE JAPAN STEEL WORKS, LTD., Tokyo (JP)

(72) Inventors: Ryuichiro MAENISHI, Tokyo (JP); Soma TANAKA, Tokyo (JP)

(21) Appl. No.: 17/449,811

(22) Filed: Oct. 3, 2021

(30) Foreign Application Priority Data
Dec. 11, 2020 (JP) 2020-205659

(51) Int. Cl. B29C 48/92; B29C 48/37

(52) U.S. Cl. CPC B29C 48/92; B29C 48/37; B29C 2948/92885; B29C 2948/9259; B29C 2948/92019

(57) ABSTRACT

In an extrusion molding apparatus according to an embodiment, a control unit configured to perform feedback control for a rotation speed of a pump so as to bring a pressure measured by a pressure sensor closer to a target pressure determines a current state and a reward for an action selected in the past based on a difference between the measured pressure and the target pressure, updates a control condition, which is a combination of a state and an action, based on the reward, selects an optimum action corresponding to the current state under the updated control condition, and controls the rotation speed of the pump based on the optimum action.

### INCORPORATION BY REFERENCE

This application is based upon and claims the benefit of priority from Japanese patent application No. 2020-205659, filed on Dec. 11, 2020, the disclosure of which is incorporated herein in its entirety by reference.

### BACKGROUND

The present disclosure relates to an extrusion molding apparatus and its control method.

As disclosed in Japanese Unexamined Patent Application Publication No. 2020-152097, the inventors of the present application have developed an extrusion molding apparatus and its control method using machine learning.

### SUMMARY

The inventors have found various problems during the development of an extrusion molding apparatus and its control method.

Other problems and novel features will be clarified from the descriptions in this specification and the attached drawings.

In an extrusion molding apparatus according to an embodiment, a control unit, which is configured to perform feedback control for a rotation speed (e.g., number of revolutions per minute) of a pump so as to bring a pressure measured by a pressure sensor closer to a target pressure, determines a current state and a reward for an action selected in the past based on a difference between the measured pressure and the target pressure, updates a control condition based on the reward and selects an optimum action corresponding to the current state under the updated control condition, the control condition being a combination of a state and an action, and controls the rotation speed of the pump based on the optimum action.

According to the above-described embodiment, it is possible to provide a manufacturing apparatus capable of manufacturing an excellent resin film.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic cross-sectional view showing an overall configuration of an extrusion molding apparatus according to a first embodiment;

FIG. 2 is a cross-cross-sectional view of a T-die 20;

FIG. 3 is a partial perspective view of a lower side (a lip side) of the T-die 20;

FIG. 4 is a block diagram showing a configuration of a control unit 70 according to the first embodiment;

FIG. 5 is a flowchart showing an outline of a method for controlling an extrusion molding apparatus according to the first embodiment;

FIG. 6 is a flowchart showing details of a process for adjusting a rotation speed of a gear pump GP (step S2);

FIG. 7 is a flowchart showing details of a process for controlling a rotation speed of a screw 12 (step S3) during the manufacturing of a product; and

FIG. 8 is a block diagram showing a configuration of a control unit 70 according to a second embodiment.

### DESCRIPTION OF EMBODIMENTS

Specific embodiments are explained hereinafter in detail with reference to the drawings. However, the present disclosure is not limited to the below-shown embodiments. Further, the following descriptions and the drawings are simplified as appropriate for clarifying the explanation.

### First Embodiment

### <Overall Configuration of Extrusion Molding Apparatus>

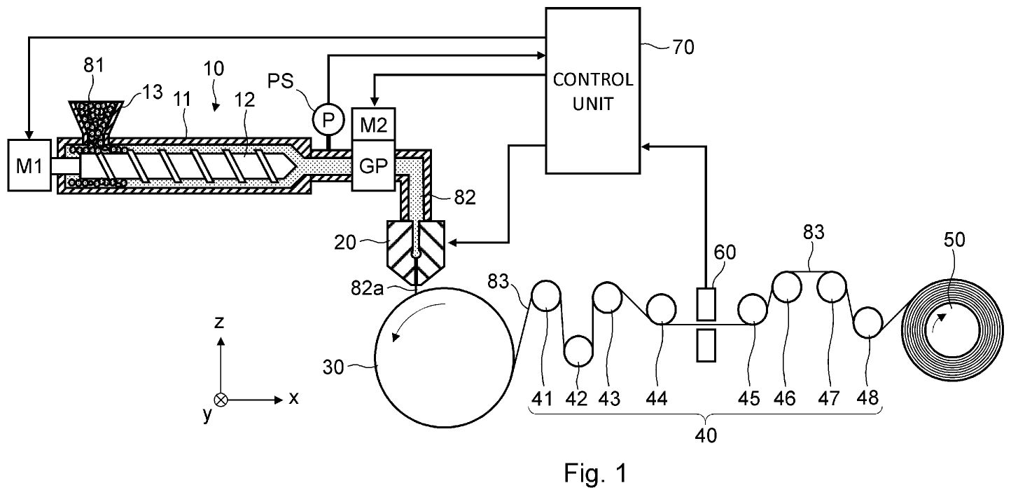

Firstly, an overall configuration of an extrusion molding apparatus according to a first embodiment will be described with reference to FIG. 1. FIG. 1 is a schematic cross-sectional view showing the overall configuration of an extrusion molding apparatus according to the first embodiment. The extrusion molding apparatus according to this embodiment is a resin-film manufacturing apparatus.

Note that, needless to say, right-handed xyz-orthogonal coordinates shown in FIG. 1 and other drawings are shown for the sake of convenience for explaining the positional relation among components. In general, the z-axis positive direction is the vertically upward direction and the xy-plane is a horizontal plane throughout the drawings.

Further, in this specification, the term “resin film” includes a resin sheet.

As shown in FIG. 1, the extrusion molding apparatus according to the first embodiment includes an extruder 10, a T-die 20, a cooling roll 30, a group of conveyor rolls 40 (hereinafter also referred to as a conveyor roll group 40), a winder 50, a thickness sensor 60, and a control unit 70. The extrusion molding apparatus according to the first embodiment is an extrusion-molding type resin-film manufacturing apparatus in which a film-like molten resin 82a is extruded from a gap between lips of the T-die 20 connected to the extruder 10.

The extruder 10 is, for example, a screw-type extruder. In the extruder 10 shown in FIG. 1, a screw 12 extending in the x-axis direction is housed in a cylinder 11 extending in the x-axis direction. A hopper 13 for charging resin pellets 81, which are a raw material for a resin film 83, is provided over the upper side of the cylinder 11 near the end thereof located on the negative side in the x-axis direction.

A motor M1 is connected to the base of the screw 12. The motor M1 is a driving source that drives the screw 12.

Note that only one screw 12 may be provided, or a plurality of screws 12 may be provided. For example, an extruder 10 with one screw 12 is called a single-screw extruder, while an extruder 10 with two screws 12 is called a twin-screw extruder.

The resin pellets 81 supplied from the hopper 13 are extruded (i.e., pushed) from the base of the screw 12, which is rotated by the motor M1, toward the tip thereof, i.e., extruded (i.e., pushed) in the x-axis positive direction. The resin pellets 81 are heated and compressed by the rotating screw 12 inside the cylinder 11, and are transformed into molten resin 82.

As shown in FIG. 1, the T-die 20 is connected to the lower end of an L-shaped pipe which extends in the x-axis positive direction from the tip of the extruder 10 (the end on the positive side in the x-axis direction) and then extends downward (in the z-axis negative direction). The film-like molten resin 82a is extruded downward (in the z-axis negative direction) from the gap between the lips of the T-die 20 located at the lower end thereof. Note that the distance between the lips (hereinafter also referred to as the lip distance) of the T-die 20 is adjustable. As will be described later in detail, the lip distance of the T-die 20 can be adjusted at a plurality of places along the longitudinal direction of the lips (in the y-axis direction) so that the thickness of the manufactured resin film 83 becomes uniform in the width direction thereof (in the y-axis direction).

Note that as shown in FIG. 1, a gear pump GP is provided in the horizontal part of the pipe, which connects the extruder 10 with the T-die 20. The gear pump GP sucks in (i.e., takes in) the molten resin extruded from the extruder 10 and discharges the sucked-in molten resin to the T-die 20. The gear pump GP is composed of, for example, a pair of gears engaged with each other. One of the gears of the gear pump GP is driven by a motor M2.

Note that the pump, which sucks in the molten resin extruded from the extruder 10 and discharges it to the T-die 20, is not limited to the gear pump, and may be any of other types of pumps.

As shown in FIG. 1, a pressure sensor PS is provided on the suction side of the gear pump GP in the pipe connecting the extruder 10 with the T-die 20. The pressure sensor PS measures a pressure of the molten resin on the suction side of the gear pump GP. The pressure measured by the pressure sensor PS is input to the control unit 70.

The cooling roll 30 discharges a resin film 83, which is formed as the film-like molten resin 82a solidifies, while cooling the film-like molten resin 82a extruded from the T-die 20. The resin film 83 discharged from the cooling roll 30 is conveyed through the conveyor roll group 40 and is wound up by the winder 50. In the example shown in FIG. 1, the conveyor roll group 40 includes eight conveyor rolls 41 to 48. The number and arrangement of conveyor rolls are determined as desired.

The thickness sensor 60 is, for example, a noncontact-type thickness sensor and measures the distribution of thicknesses (hereinafter also referred to as the thickness distribution) of the resin film 83, which was discharged from the cooling roll 30 and is being conveyed, in the width direction thereof. In the example shown in FIG. 1, the thickness sensor 60 is disposed so as to vertically sandwich the resin film 83, which is being conveyed in the horizontal direction, between the conveyor rolls 44 and 45. Since the thickness sensor 60 is the noncontact type, it can be scanned (i.e., moved) in the width direction of the resin film 83 (in the y-axis direction). Therefore, it is possible to measure the thickness distribution of the resin film 83 in the width direction thereof by using a compact thickness sensor 60. Further, since the resin film 83 is conveyed in the horizontal direction, the thickness distribution can be accurately measured even when the thickness sensor 60 is scanned (i.e., moved).

As shown in FIG. 1, the control unit 70 individually performs feedback control for the rotation speed (e.g., number of revolutions per minute) of the screw 12 and for the rotation speed of the gear pump GP so as to bring the pressure measured by the pressure sensor PS closer to a target pressure (or to maintain the measured pressure at the target pressure). Specifically, the control unit 70 performs feedback control for the output of each of the motors M1 and M2, which are the driving sources of the screw 12 and the gear pump GP, respectively. It is possible to, by maintaining the pressure of the molten resin on the suction side of the gear pump GP at the target pressure, maintain the amount of molten resin flowing into the T-die 20 at a constant amount.

When the rotation speed of the screw 12 driven by the motor M1 is increased, the amount of molten resin extruded (i.e., pushed) toward the gear pump GP increases, so that the pressure of the molten resin on the suction side of the gear pump GP rises. Conversely, when the rotation speed of the screw 12 is decreased, the amount of molten resin extruded toward the gear pump GP decreases, so that the pressure of the molten resin on the suction side of the gear pump GP decreases.

Therefore, when the control unit 70 performs feedback control for the rotation speed of the screw 12, if the pressure measured by the pressure sensor PS is lower than the target pressure, the rotation speed of the screw 12 (i.e., the output of the motor M1) is increased. Conversely, if the measured pressure is higher than the target pressure, the rotation speed of the screw 12 (i.e., the output of the motor M1) is decreased.

Meanwhile, when the rotation speed of the gear pump GP driven by the motor M2 is increased, the amount of molten resin sucked in by the gear pump GP increases, so that the pressure of the molten resin on the suction side of the gear pump GP decreases. Conversely, when the rotation speed of the gear pump GP is decreased, the amount of molten resin sucked in by the gear pump GP decreases, so that the pressure of the molten resin on the suction side of the gear pump GP rises.

Therefore, when the control unit 70 performs feedback control for the rotation speed of the gear pump GP, if the pressure measured by the pressure sensor PS is lower than the target pressure, the rotation speed of the gear pump GP (i.e., the output of the motor M2) is decreased. Conversely, if the measured pressure is higher than the target pressure, the rotation speed of the screw 12 (i.e., the output of the motor M2) is increased.

Further, as shown in FIG. 1, the control unit 70 performs feedback control for the lip distance of the T-die 20 based on the thickness distribution of the resin film 83 acquired from the thickness sensor 60. More specifically, the control unit 70 controls the lip distance of the T-die 20 so that the thickness of the resin film 83 becomes uniform in the width direction thereof.

Note that the configuration and the operation of the control unit 70 will be described later in a more detailed manner.

### <Configuration of T-die 20>

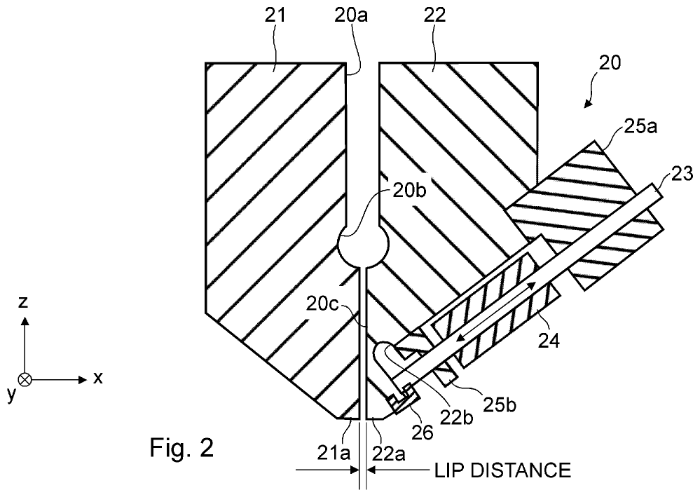

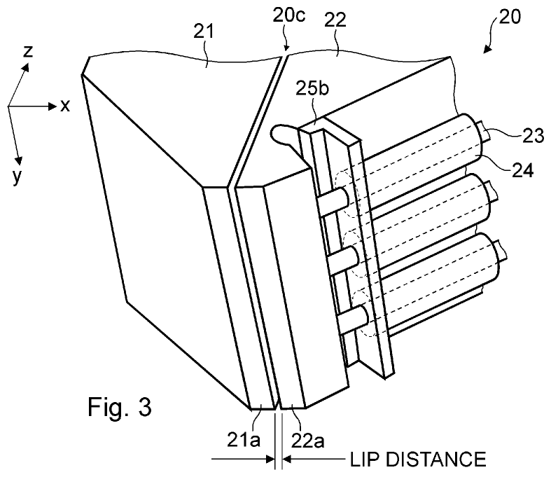

The structure of the T-die 20 will be described hereinafter in a more detailed manner with reference to FIGS. 2 and 3. FIG. 2 is a cross-sectional view of the T-die 20. Further, FIG. 3 is a partial perspective view of the lower side (the lip side) of the T-die 20.

As shown in FIGS. 2 and 3, the T-die 20 is composed of a pair of die blocks 21 and 22 that are arranged so as to abut against each other. In each of the pair of die blocks 21 and 22, which are arranged so as to abut against each other, a tapered part that is inclined downward from the outer-side surface toward the inner-side surface (the abutting surface) is formed. That is, thin lips 21a and 22a are provided at the lower ends of the abutting surfaces of the die blocks 21 and 22, respectively.

In the abutting surfaces of the pair of die blocks 21 and 22, an inlet port 20a, a manifold 20b, and a slit 20c are formed. The inlet port 20a extends downward (in the z-axis negative direction) from the upper surface of the T-die 20. The manifold 20b extends from the lower end of the inlet port 20a in the y-axis positive direction and the y-axis negative direction. In this way, the inlet port 20a and the manifold 20b are formed in a T-shape in the T-die 20.

Further, the slit 20c extending from the bottom surface of the manifold 20b to the lower surface of the T-die 20 extends in the y-axis direction. The molten resin 82 is extruded downward from the slit 20c (i.e., from the gap between the lips 21a and 22a) through the inlet port 20a and the manifold 20b.

Note that while the lip 21a is a fixed stationary lip, the lip 22a is a movable lip connected to heat bolts 23. In the lip 22a, a cut-out groove 22b is formed so as to extend obliquely upward from the outer-side surface toward the abutting surface. The lip 22a is pushed and pulled by the heat bolts 23, so that the lip 22a can be moved by using the bottom of the cut-out groove 22b as a fulcrum. As described above, only the lip 22a is formed as a movable lip, so that the lip distance can be easily adjusted by a simple structure.

The heat bolts 23 extend obliquely upward along the tapered part of the die block 22. The heat bolts 23 are supported by holders 25a and 25b fixed to the die block 22. More specifically, the heat bolts 23 are screwed into threaded holes formed in the holder 25a. The tightness of each of the heat bolts 23 can be adjusted as desired. In contrast, although the heat bolts 23 are inserted through through-holes formed in the holder 25b, they are not fixed to the holder 25b. Note that the holders 25a and 25b do not necessarily have to be formed as components that are provided separately from the die block 22. That is, they may be integrally formed with the die block 22.

Note that as shown in FIG. 3, a plurality of heat bolts 23 are arranged along the longitudinal direction of the lips 21a and 22a (in the y-axis direction). The longitudinal direction of the lips 21a and 22a corresponds to (i.e., substantially parallel to) the width direction of the resin film. Although only three heat bolts 23 are provided in the example shown in FIG. 3 for simplifying the drawing, the number of heat bolts 23 provided in the die block is usually larger than three.

One heater 24 is provided for each heat bolt 23 to heat that heat bolt 23. In the example shown in FIGS. 2 and 3, for each heat bolt 23, a heater 24 is provided so as to cover the outer peripheral surface of that heat bolt 23 between the holders 25a and 25b. It is possible, by tightening (i.e., screwing) the heat bolts 23, to push the lip 22a with the lower end surfaces of the heat bolts 23. Further, the lower ends of the heat bolts 23 are connected to the lip 22a by a connecting member 26 which has a U-shape in cross section and is fixed to the lip 22a. Therefore, by loosening (i.e., unscrewing) the heat bolts 23, the lip 22a can be pulled through the connecting member 26.

It is possible to adjust the distance between the lips 21a and 22a by adjusting the tightness of the heat bolts 23. Specifically, when the tightness of the heat bolts 23 are increased, the heat bolts 23 push the lip 22a, so that the distance between the lips 21a and 22a is reduced. On the other hand, when the tightness of the heat bolt 23 are reduced, the distance between the lips 21a and 22a is increased. For example, the tightness of the heat bolts 23 are manually adjusted.

Further, it is possible to finely adjust the distance between the lips 21a and 22a by the amounts of the thermal expansions (hereinafter also referred to as the thermal expansion amounts) of the heat bolts 23 caused by the heaters 24. Specifically, when the heating temperatures of the heaters 24 are raised, the thermal expansion amounts of the heat bolts 23 increase, so that the heat bolts 23 push the lip 22a and the distance between the lips 21a and 22a thereby is reduced. On the other hand, when the heating temperatures of the heaters 24 are lowered, the thermal expansion amounts of the heat bolts 23 decrease, so that the distance between the lips 21a and 22a is increased. The thermal expansion amount of each heat bolt 23, i.e., the heating by each heater 24 is controlled by the control unit 70.

### <Configuration of Control Unit 70 According to Comparative Example>

An extrusion molding apparatus according to a comparative example has an overall configuration similar to that of the extrusion molding apparatus according to the first embodiment shown in FIG. 1. In the comparative example, the control unit 70 individually performs, by using PID control, feedback control for the rotation speed of the screw 12 and for the rotation speed of the gear pump GP based on the pressure measured by the pressure sensor PS. In the case of the PID control, it is necessary to adjust a parameter(s) every time a process condition(s) is changed. In general, an operator adjusts the parameter(s) through trial and error, thus causing a problem that a large amount of time is taken and a large amount of resin material is required to adjust the parameter(s).

### <Configuration of Control Unit 70 According to First Embodiment>

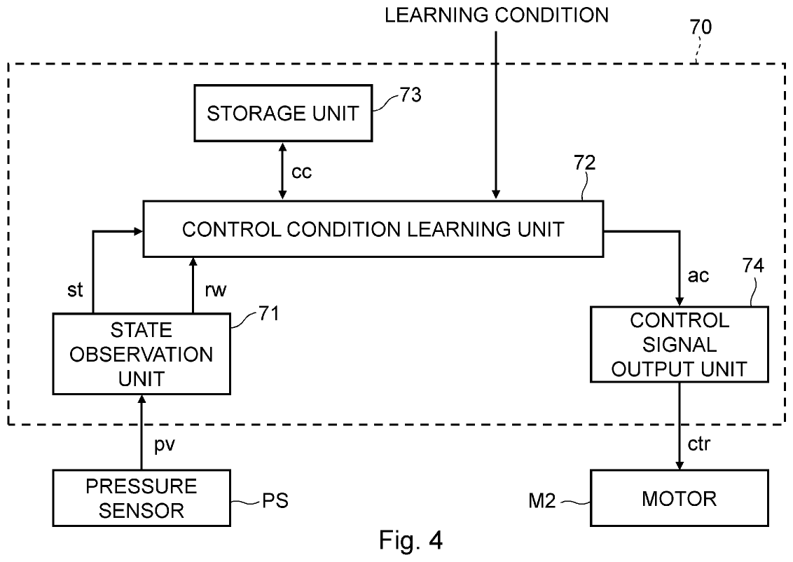

Next, the configuration of the control unit 70 according to the first embodiment will be described in a more detailed manner with reference to FIG. 4. FIG. 4 is a block diagram showing the configuration of the control unit 70 according to the first embodiment. As shown in FIG. 4, the control unit 70 according to the first embodiment includes a state observation unit 71, a control condition learning unit 72, a storage unit 73, and a control signal output unit 74.

The control unit 70 individually performs feedback control for the output of each of the motors M1 and M2, which are the driving sources of the screw 12 and the gear pump GP, respectively. Although FIG. 4 shows only the case where the rotation speed of the motor M2, which is the driving source of the gear pump GP, is controlled, the motor M1, which is the driving source of the screw 12, is controlled in a similar manner. That is, when the rotation speed of the motor M1, which is the driving source of the screw 12, is controlled, the diagram shown in FIG. 4 can also be applied by replacing the motor M1 by the motor M2.

Note that each of the functional blocks constituting the control unit 70 can be implemented by hardware such as a CPU (Central Processing Unit), a memory, and other circuits, or can be implemented by software such as a program(s) loaded in a memory or the like. Therefore, each functional block can be implemented in various forms by computer hardware, software, or combinations thereof.

The state observation unit 71 calculates a control error err from a pressure pv measured by the pressure sensor PS. The control error err is a difference between the measured pressure pv and a target pressure.

Then, the state observation unit 71 determines a current state st and a reward rw for an action ac selected in the past (e.g., selected in the last time) based on the calculated control error err.

The state st is defined in advance in order to classify values of the control error err, which can take any of infinite number of values, into a finite number of groups. As a simple example for an explanatory purpose, when the control error is represented by err, for example, a range “−4.0 MPa≤err<−3.0 MPa is defined as a state st1; a range “−3.0 MPa≤err<−2.0 MPa is defined as a state st2; a range “−2.0 MPa≤err<−1.0 MPa is defined as a state st3; a range “−1.0 MPa≤err<+1.0 MPa is defined as a state st4; a range “+1.0 MPa≤err<+2.0 MPa is defined as a state st5; a range “+2.0 MPa≤err<+3.0 MPa is defined as a state st6; a range “+3.0 MPa≤err<+4.0 MPa is defined as a state st7; and a range “+4.0 MPa≤err<+5.0 MPa is defined as a state st8. In practice, in many cases, a larger number of states st each having a narrower range may be defined.

The reward rw is an index for evaluating an action ac that was selected in a past state st.

Specifically, when the absolute value of the calculated current control error err is smaller than the absolute value of the past control error err, the state observation unit 71 determines that the action ac selected in the past is appropriate and sets, for example, a positive value to the reward rw. In other words, the reward rw is determined so that the previously selected action ac is more likely to be selected again in the same state st as the past state.

On the other hand, if the absolute value of the calculated current control error err is larger than the absolute value of the past control error err, the state observation unit 71 determines that the action ac selected in the past is inappropriate and sets, for example, a negative value to the reward rw. In other words, the reward rw is determined so that the previously selected action ac is less likely to be selected again in the same state st as the past state.

Note that specific examples of the reward rw will be described later. Further, the value of the reward rw can be determined as appropriate. For example, the reward rw may have a positive value at all times, or the reward rw may have a negative value at all times.

The control condition learning unit 72 performs reinforcement learning for each of the motors M1 and M2. Specifically, the control condition learning unit 72 updates a control condition (a learning result) based on the reward rw, and selects an optimum action ac corresponding to the current state st under the updated control condition. The control condition is a combination of a state st and an action ac. Table 1 shows simple control conditions (learning results) corresponding to the above-described states st1 to st8. In the example shown in FIG. 4, the control condition learning unit 72 stores the updated control condition cc in the storage unit 73, which is, for example, a memory, and updates the control condition cc by reading it from the storage unit 73.

The Table 1 shows control conditions (learning results) by Q learning, which is an example of the reinforcement learning. The aforementioned eight states st1 to st8 are shown in the uppermost row in the Table 1. That is, the eight states st1 to st8 are shown in the second to ninth columns, respectively. Meanwhile, five actions ac1 to ac5 are shown in the leftmost column in the Table 1. That is, the five actions ac1 to ac5 are shown in the second to sixth rows, respectively.

TABLE 1

| | st1 | st2 | st3 | st4 | st5 | st6 | st7 | st8 |
|---|---|---|---|---|---|---|---|---|
| | −4.0~−3.0 | −3.0~−2.0 | −2.0 ~ −1.0 | −1.0~+1.0 | +1.0~+2.0 | +2.0~+3.0 | +3.0~+4.0 | +4.0~+5.0 |
| | MPa | MPa | MPa | MPa | MPa | MPa | MPa | MPa |
| ac1 | +5.5 | +4.2 | +3.5 | +2.2 | −3.0 | −4.4 | −4.6 | −5.2 |
| −1.0% | | | | | | | | |
| ac2 | +4.2 | +4.6 | +4.4 | +2.5 | −0.2 | −0.8 | −2.2 | −3.5 |
| −0.5% | | | | | | | | |
| ac3 | −2.2 | −1.5 | +2.2 | +5.2 | +2.3 | +2.0 | +0.1 | −2.3 |
| 0% | | | | | | | | |
| ac4 | −6.2 | −5.2 | +1.5 | +2.5 | +3.0 | +3.5 | +3.6 | +3.2 |
| +0.5% | | | | | | | | |
| ac5 | −4.6 | −4.2 | −4.2 | −3.2 | −2.5 | +0.3 | +2.6 | +5.2 |
| +1.0% | | | | | | | | |

Note that, in the example shown in the Table 1, an action for reducing the output of the motor M2 shown in FIG. 4 by 1.0% is defined as the action ac1 (Output Change: −1%). An action for reducing the output of the motor M2 by 0.5% is defined as the action ac2 (Output Change: −0.5%). An action for maintaining the output of the motor M2 is defined as the action ac3 (Output Change: 0%). An action for increasing the output of the motor M2 by 0.5% is defined as the action ac4 (Output Change: +0.5%). An action for increasing the output of the motor M2 by 1.0% is defined as the action ac5 (Output Change: +1.0%). The example shown in the Table 1 is merely a simple example for an explanatory purpose. That is, in practice, in many cases, a larger number of more detailed actions ac may be defined.

A value determined by a combination of a state st and an action ac in the Table 1 is called a quality Q (st, ac). After an initial value is given, the quality Q is successively updated based on the reward rw by using a known updating formula. The initial value of the quality Q is included in, for example, the learning condition shown in FIG. 4. The learning condition is input by, for example, an operator. The initial value of the quality Q may be stored in the storage unit 73, and for example, a learning result in the past may be used as the initial value. Further, for example, the states st1 to st8 and the actions ac1 to ac5 shown in the Table 1 are included in the learning condition shown in FIG. 4.

The quality Q will be described by using the state st7 in the Table 1 as an example. In the state st7, since the control error err is no smaller than +3.0 MPa and smaller than +4.0 MPa, the measured pressure pv is higher than the target pressure and the rotation speed of the gear pump GP is too low. That is, since the output of the motor M2, which drives the gear pump GP, is too low, it is necessary to increase the output of the motor M2. Therefore, as a result of learning by the control condition learning unit 72, the qualities Q of the actions ac4 and ac5 for increasing the output of the motor M2 are large. On the other hand, the qualities Q of the actions ac1 and ac2 for decreasing the output of the motor M2 are small.

In the example shown in the Table 1, for example, when the control error err is +3.5 MPa, the state st falls in the state st7. Therefore, the control condition learning unit 72 selects the optimum action ac4 having the maximum quality Q in the state st7, and outputs the selected action ac4 to the control signal output unit 74.

The control signal output unit 74 outputs a control signal ctr for increasing the output of the motor M2 by 0.5% to the motor M2 based on the action ac4 received from the control condition learning unit 72.

Then, when the absolute value of the next control error err is smaller than the absolute value 3.5 MPa of the current control error err, the state observation unit 71 determines that the selecting of the action ac4 in the current state st7 is appropriate, and outputs a reward rw having a positive value. Therefore, the control condition learning unit 72 updates the control condition so as to increase the quality+3.6 of the action ac4 in the state st7 according to the reward rw. As a result, in the case of the state st7, the control condition learning unit 72 continuously selects the action ac4.

On the other hand, when the absolute value of the next control error err is larger than the absolute value of 3.5 MPa of the current control error err, the state observation unit 71 determines that the selecting of the action ac4 in the current state st7 is inappropriate, and outputs a reward rw having a negative value. Therefore, the control condition learning unit 72 updates the control condition so as to reduce the quality+3.6 of the action ac4 in the state st7 according to the reward rw. As a result, in the case of the state st7, when the quality of the action ac4 in the state st7 becomes smaller than the quality+2.6 of the action ac5, the control condition learning unit 72 selects the action ac5 instead of the action ac4.

Note that the timing of the updating of the control condition is not limited to the next time (e.g., not limited to when the control error is calculated the next time). That is, the timing of the updating may be determined as appropriate while taking a time lag or the like into consideration. Further, in the initial stage of the learning, the action ac may be randomly selected in order to expedite the learning. Further, although the reinforcement learning by simple Q learning is described above with reference to the Table 1, there are various types of learning algorithms such as Q learning, AC (Actor-Critic) method, TD learning, and Monte Carlo method, and the learning algorithm is not limited to in any type of algorithms. For example, when the number of states st and actions ac increase and the number of combinations thereof explosively increases, the algorithm may be selected, such as using the AC method, according to the situation.

Further, in the AC method, a probability distribution function is used as a policy function in many cases. The probability distribution function is not limited to the normal distribution function. For example, for the purpose of simplification, a sigmoid function, a soft max function, or the like may be used. The sigmoid function is a function that is used most commonly in neural networks. Because the reinforcement learning is one of the types of the machine learning that is the same as the neural network, it can use the sigmoid function. Further, the sigmoid function has another advantage that the function itself is simple and easily handled.

As described above, there are various learning algorithms and functions to be used, and an optimum algorithm and an optimum function may be selected as appropriate for the process.

As explained above, the PID control is not used in the extrusion molding apparatus according to the first embodiment. Therefore, to begin with, there is no need to adjust a parameter(s) which would otherwise be necessary when a process condition is changed. Further, the control unit 70 updates the control condition (the learning result) based on the reward rw through the reinforcement learning, and selects an optimum action ac corresponding to the current state st under the updated control condition. Therefore, even when a process condition(s) is changed, it is possible reduce the time taken for the adjustment and the amount of a resin material required therefor as compared to those in the comparative example.

Note that the products manufactured by the extrusion molding apparatus according to the first embodiment are not limited to resin films, and may be pipe materials, rod materials, covering materials for wires, or the like. Further, the extrusion molding apparatus according to the first embodiment may be used for extrusion molding of parison for blow molding.

### <Outline of Method for Controlling Extrusion Molding Apparatus>

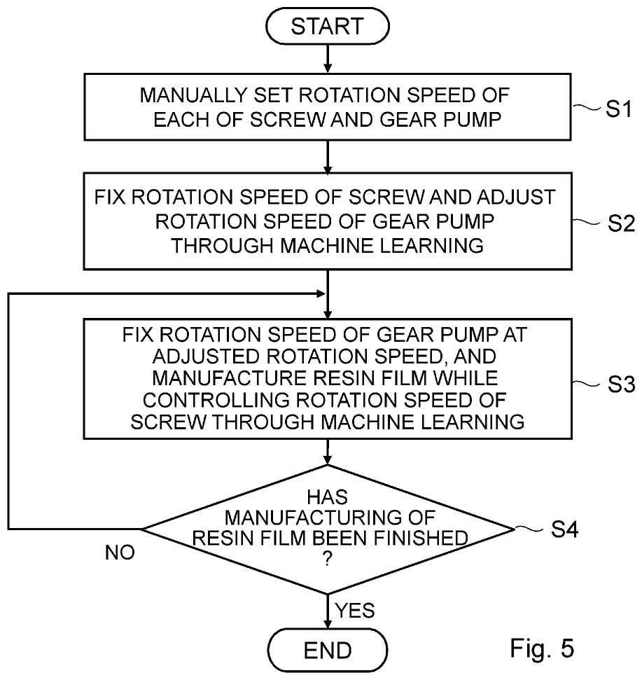

Next, an outline of a method for controlling an extrusion molding apparatus according to the first embodiment will be described with reference to FIG. 5. FIG. 5 is a flowchart showing an outline of a method for controlling an extrusion molding apparatus according to the first embodiment. The following description will be given while referring to FIG. 1 as appropriate as well as referring to FIG. 5.

Firstly, as shown in FIG. 5, when the extrusion molding apparatus is started up, the rotation speed of each of the screw 12 and the gear pump GP is manually set (Step S1). Specifically, the rotation speed of each of the screw 12 and gear pump GP is gradually increased to its standard value for the manufacturing process. As the rotation speeds are increased, the amount of resin pellets 81 supplied from the hopper 13 is also gradually increased.

Next, as shown in FIG. 5, the rotation speed of the screw 12 is fixed at the aforementioned standard value, and the rotation speed of the gear pump GP is adjusted through machine learning (Step S2). Specifically, the control unit 70 adjusts the rotation speed of the gear pump GP by performing feedback control therefor through machine learning so that the pressure measured by the pressure sensor PS is brought closer to a target pressure (or so that the measured pressure is maintained at the target pressure). Note that, in the step S2, since the rotation speed of the screw 12 is fixed, the amount of resin pellets 81 supplied from the hopper 13 is also fixed.

Next, as shown in FIG. 5, the rotation speed of the gear pump GP is fixed at the adjusted value, and a resin film is manufactured while controlling the rotation speed of the screw 12 through machine learning (Step S3). Specifically, in the step S2, once the rotation speed of the screw 12 is stabilized, the rotation speed of the gear pump GP is fixed at the adjusted value at that moment. Then, a resin film is manufactured while having the control unit 70 perform feedback control for the rotation speed of the screw 12 through machine learning so as to bring the pressure measured by the pressure sensor PS closer to the target pressure (or so as to maintain the measured pressure at the target pressure). Note that, in the step S3, the amount of resin pellets 81 supplied from the hopper 13 is also changed (i.e., adjusted) according to the rotation speed of the screw 12.

When the manufacturing of the resin film 83 has not been finished (Step S4 No), the process returns to the step S3 and the control is continued. On the other hand, when the manufacturing of the resin film 83 has been completed (Step S4 YES), the control is finished. That is, the step S3 is repeated until the manufacturing of the resin film 83 is completed.

In FIG. 5, the steps S1 and S2 are preparatory processes for manufacturing a resin film, which is the product, and the step S3 is the manufacturing process of the resin film, which is the product.

### <Details of Step S2>

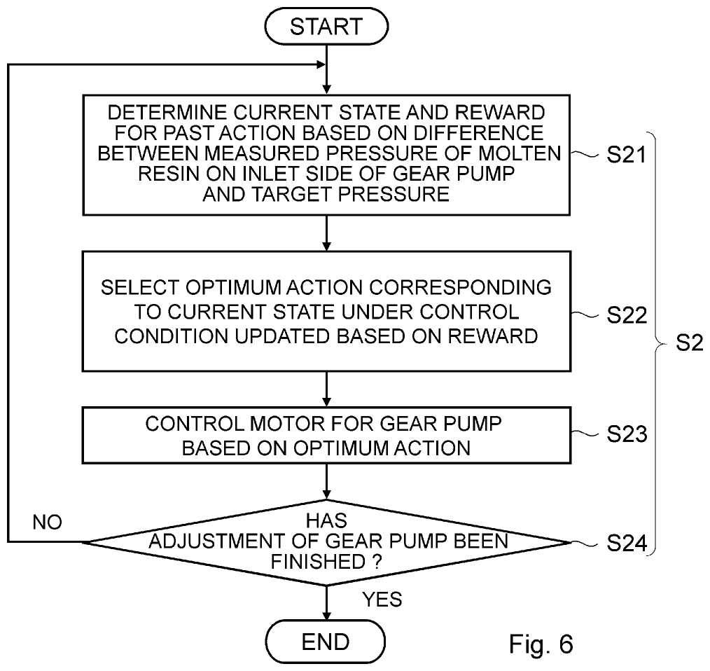

Next, details of the process for adjusting the rotation speed of the gear pump GP (Step S2) will be described with reference to FIG. 6. FIG. 6 is a flowchart showing the details of the process for adjusting the rotation speed of the gear pump GP (Step S2). The following description will be given while referring to FIG. 4 as appropriate as well as referring to FIG. 6.

Firstly, as shown in FIG. 6, the state observation unit 71 of the control unit 70 shown in FIG. 4 determines a current state st and a reward rw for an action ac selected in the past based on a difference (a control error err) between the measured pressure of the molten resin on the inlet side of the gear pump GP and the target pressure (Step S21). Note that, at the start of the control, since there is no action ac selected in the past (e.g., no action ac selected in the last control) and hence it is impossible to determine the reward rw. Therefore, only the current state st at the start of the control is determined.

Next, the control condition learning unit 72 of the control unit 70 updates a control condition, which is a combination of a state st and an action ac, based on the reward rw. Then, the control condition learning unit 72 selects an optimum action ac corresponding to the current state st under the updated control condition (Step S22). Note that, at the start of the control, the control condition is not updated and remains as the initial value, but the optimum action ac corresponding to the state st at the start of the control is selected.

Then, the control signal output unit 74 of the control unit 70 outputs a control signal ctr to the motor M2 of the gear pump GP based on the optimum action ac selected by the control condition learning unit 72 (Step S23).

When the rotation speed of the gear pump GP has not been stabilized and hence the adjustment of the rotation speed of the gear pump GP has not been completed (Step S24 NO), the process returns to the step S21 and the adjustment of the rotation speed of the gear pump GP is continued. On the other hand, when the rotation speed of the gear pump GP has been stabilized, the adjustment of the rotation speed of the gear pump GP is finished (Step S24 YES). That is, the steps S21 to S23 are repeated until the adjustment of the rotation speed of the gear pump GP is completed. When the adjustment of the rotation speed of the gear pump GP has been completed, i.e., when the step S2 has been finished, the process goes to the step S3 shown in FIG. 5.

As explained above, in the extrusion molding apparatus according to the first embodiment, the PID control is not used for the adjustment of the rotation speed of the gear pump GP. Therefore, to begin with, there is no need to adjust a parameter(s) which would otherwise be necessary when a process condition is changed. Further, the control condition (the learning result) is updated based on the reward rw through the reinforcement learning using a computer, and an optimum action ac corresponding to the current state st is selected under the updated control condition. Therefore, even when a process condition(s) is changed, it is possible reduce the time taken for the adjustment of the rotation speed of the gear pump GP and the amount of a resin material required therefor as compared to those in the comparative example.

### <Details of Step S3>

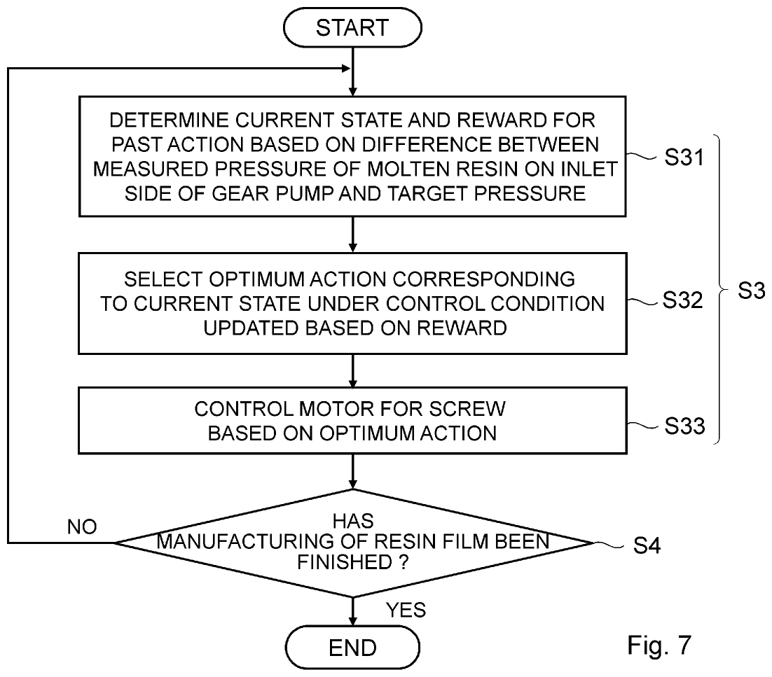

Next, details of the process for controlling the rotation speed of the screw 12 (Step S3) during the manufacturing of a product will be described with reference to FIG. 7. FIG. 7 is a flowchart showing details of a process for controlling the rotation speed of the screw 12 (Step S3) during the manufacturing of a product. The following description will be given while referring to FIG. 4 as appropriate as well as referring to FIG. 7. In the following description, the motor M1 in FIG. 4 is replaced by the motor M2.

Firstly, as shown in FIG. 7, the state observation unit 71 of the control unit 70 shown in FIG. 4 determines a current state st and a reward rw for an action ac selected in the past based on a difference (a control error err) between the measured pressure of the molten resin on the inlet side of the gear pump GP and the target pressure (Step S31). Note that, at the start of the control, since there is no action ac selected in the past (e.g., no action ac selected in the last control) and hence it is impossible to determine the reward rw. Therefore, only the current state st at the start of the control is determined.

Next, the control condition learning unit 72 of the control unit 70 updates a control condition, which is a combination of a state st and an action ac, based on the reward rw. Then, the control condition learning unit 72 selects an optimum action ac corresponding to the current state st under the updated control condition (Step S32). Note that, at the start of the control, the control condition is not updated and remains as the initial value, but the optimum action ac corresponding to the state st at the start of the control is selected.

Then, the control signal output unit 74 of the control unit 70 outputs a control signal ctr to the motor M1 of the screw 12 based on the optimum action ac selected by the control condition learning unit 72 (Step S33).

When the manufacturing of the resin film 83 has not been completed (Step S4 NO), the process returns to the step S31 and the control is continued. On the other hand, when the manufacturing of the resin film 83 has been completed (Step S4 YES), the control is finished. That is, the steps S31 to S33 are repeated until the manufacturing of the resin film 83 is completed.

As explained above, in the extrusion molding apparatus according to the first embodiment, the PID control is not used for the control of the rotation speed of the screw 12 during the manufacturing of a product. Therefore, to begin with, there is no need to adjust a parameter(s) which would otherwise be necessary when a process condition is changed. Further, the control condition (the learning result) is updated based on the reward rw through the reinforcement learning using a computer, and an optimum action ac corresponding to the current state st is selected under the updated control condition. Therefore, as compared to the comparative example, it is possible to improve the yield rate of products in a situation in which a process condition(s) is changed, and to flexibly respond to fluctuations in the pressure of the molten resin caused by an external factor(s) during the manufacturing of products.

### Second Embodiment

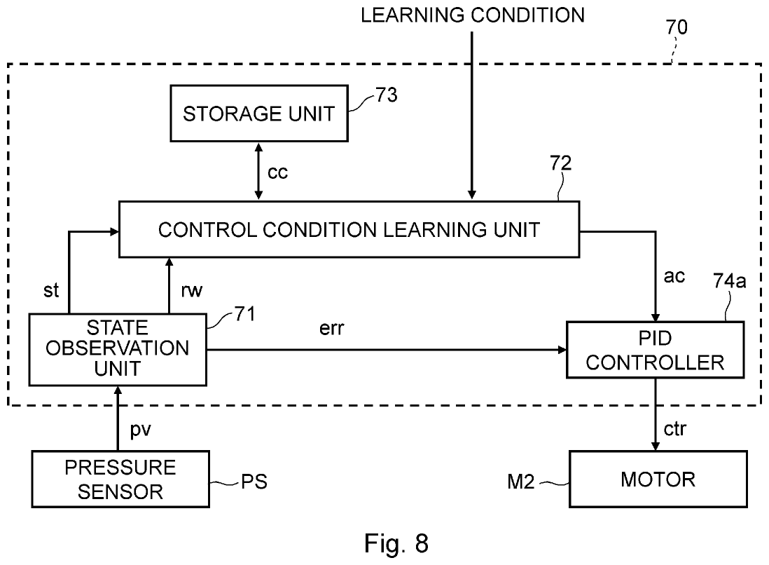

Next, an extrusion molding apparatus according to a second embodiment will be described with reference to FIG. 8. The overall configuration of the extrusion molding apparatus according to the second embodiment is similar to that of the extrusion molding apparatus according to the first embodiment shown in FIG. 1, and therefore the description thereof is omitted. The configuration of the control unit 70 in the extrusion molding apparatus according to the second embodiment differs from that in the extrusion molding apparatus according to the first embodiment.

FIG. 8 is a block diagram showing the configuration of the control unit 70 according to the second embodiment. As shown in FIG. 8, the control unit 70 according to the second embodiment includes a state observation unit 71, a control condition learning unit 72, a storage unit 73, and a PID controller 74a. That is, the control unit 70 according to the second embodiment includes a PID controller (a first PID controller) 74a that controls the output of the motor M2, which is the driving source of the gear pump GP, as the control signal output unit 74 in the control unit 70 according to the first embodiment shown in FIG. 4. The PID controller 74a is also an example of the control signal output unit.

Similarly to the first embodiment, the state observation unit 71 determines a current state st and a reward rw for an action ac selected in the past based on a difference (a control error err) between the pressure pv measured by the pressure sensor PS and the target pressure. Then, the state observation unit 71 outputs the current state st and the reward rw to the control condition learning unit 72. Further, the state observation unit 71 according to the second embodiment outputs the calculated control error err to the PID controller 74a.

Similarly to the first embodiment, the control condition learning unit 72 also performs reinforcement learning for each of the motors M1 and M2. Specifically, the control condition learning unit 72 updates a control condition (a learning result) based on the reward rw, and selects an optimum action ac corresponding to the current state st under the updated control condition. Note that in the first embodiment, the output to the motor M2 is directly changed according to the content (i.e., the details) of the action ac selected by the control condition learning unit 72. In contrast, in the second embodiment, a parameter(s) of the PID controller 74a, which controls the output of the motor M2, is changed according to the content (e.g., the details) of the action ac selected by the control condition learning unit 72.

As shown in FIG. 8, the parameter of the PID controller 74a is successively changed based on the action ac output from the control condition learning unit 72. Meanwhile, the PID controller 74a outputs a control signal ctr to the motor M2 based on the control error err received from the state observation unit 71.

As described above, in the extrusion molding apparatus according to the second embodiment, PID control is used, so that it is necessary to adjust a parameter(s) when a process condition(s) is changed. In the extrusion molding apparatus according to the second embodiment, the control unit 70 updates the control condition (the learning result) based on the reward rw through the reinforcement learning, and selects an optimum action ac corresponding to the current state st under the updated control condition. Note that the action ac in the reinforcement learning is to change a parameter of the PID controller 74a, which controls the output of the motor M2. Therefore, even when a process condition(s) is changed, it is possible to reduce the time taken for the adjustment of the parameter and the amount of a resin material required therefor as compared to those in the comparative example.

The rest of the configuration is similar to that of the first embodiment, and therefore the description thereof will be omitted. The same applies to the control of a parameter(s) of a PID controller (a second PID controller) that controls the output of the motor M1, which is the driving source of the screw 12.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An extrusion molding apparatus comprising:
an extruder configured to melt a supplied resin material and then extrude the molten resin material;
a pump configured to suck in the molten resin extruded from the extruder, and then discharge the sucked-in molten resin;
a pressure sensor configured to measure a pressure of the molten resin on a suction side of the pump; and
a control unit configured to perform feedback control for a rotation speed of the pump so as to bring the pressure measured by the pressure sensor closer to a target pressure, wherein
the control unit
determines a current state and a reward for an action selected in the past based on a difference between the measured pressure and the target pressure; and
updates a control condition based on the reward and selects an optimum action corresponding to the current state under the updated control condition, the control condition being a combination of a state and an action; and
controls the rotation speed of the pump based on the optimum action.

2. The extrusion molding apparatus according to claim 1, wherein the action is a change in an output of a power source of the pump.

3. The extrusion molding apparatus according to claim 2, wherein
the control unit comprises a first PID controller configured to control the output of the power source of the pump, and
the action is a change in the output of the power source of the pump resulting from a change in a parameter of the first PID controller.

4. The extrusion molding apparatus according to claim 1,
wherein the extruder comprises:
a cylinder; and
a screw housed in the cylinder, the screw being configured to extrude a resin material supplied into the cylinder while kneading the resin material,
wherein the control unit, after fixing the output of the power source of the pump based on a result of the control of the rotation speed of the pump, further performs feedback control for the rotation speed of the screw so as to bring the pressure measured by the pressure sensor closer to the target pressure, and
wherein the control unit, when performing feedback control for the rotation speed of the screw,
determines a current state and a reward for an action selected in the past based on a difference between the measured pressure and the target pressure;
updates a control condition based on the reward and selects an optimum action corresponding to the current state under the updated control condition, the control condition being a combination of a state and an action; and
controls the rotation speed of the screw based on the optimum action.

5. The extrusion molding apparatus according to claim 4, wherein the action that is performed when the feedback control is performed for the rotation speed of the screw is a change in an output of a power source of the screw.

6. The extrusion molding apparatus according to claim 5, wherein
the control unit comprises a second PID controller configured to control the output of the power source of the screw, and
the action that is performed when the feedback control is performed for the rotation speed of the screw is a change in the output of the power source of the screw resulting from a change in a parameter of the second PID controller.

7. An extrusion molding apparatus comprising:
an extruder comprising: a cylinder; and a screw housed in the cylinder, the extruder being configured to heat and thus melt a resin material supplied into the cylinder, and extrude the molten resin material while kneading the molten resin material by the screw;
a pump configured to suck in the molten resin extruded from the extruder, and then discharge the sucked-in molten resin;
a pressure sensor configured to measure a pressure of the molten resin on a suction side of the pump; and
a control unit configured to perform feedback control for a rotation speed of the screw so as to bring the pressure measured by the pressure sensor closer to a target pressure, wherein
the control unit
determines a current state and a reward for an action selected in the past based on a difference between the measured pressure and the target pressure; and
updates a control condition based on the reward and selects an optimum action corresponding to the current state under the updated control condition, the control condition being a combination of a state and an action; and
controls the rotation speed of the screw based on the optimum action.

8. The extrusion molding apparatus according to claim 7, wherein the action is a change in an output of a power source of the screw.

9. The extrusion molding apparatus according to claim 8, wherein
the control unit comprises a PID controller configured to control the output of the power source of the screw, and
the action is a change in the output of the power source of the screw resulting from a change in a parameter of the PID controller.

10. The extrusion molding apparatus according to claim 1, wherein the pump is a gear pump.

11. A method for controlling an extrusion molding apparatus,
the extrusion molding apparatus comprising:
an extruder configured to melt and extrude a supplied resin material;
a pump configured to suck in the molten resin extruded from the extruder, and discharge the sucked-in molten resin;
a pressure sensor configured to measure a pressure of the molten resin on a suction side of the pump; and
a control unit configured to perform feedback control for a rotation speed of the pump so as to bring the pressure measured by the pressure sensor closer to a target pressure,
the method comprising the steps of:
(a) determining, by the control unit, a current state and a reward for an action selected in the past based on a difference between the measured pressure and the target pressure; and
(b) updating, by the control unit, a control condition based on the reward and selecting an optimum action corresponding to the current state under the updated control condition, the control condition being a combination of a state and an action; and
(c) controlling, by the control unit, the rotation speed of the pump based on the optimum action.

12. The method for controlling the extrusion molding apparatus according to claim 11, wherein the action selected in the step (b) is a change in an output of a power source of the pump.

13. The method for controlling the extrusion molding apparatus according to claim 12, wherein
the control unit comprises a first PID controller configured to control the output of the power source of the pump, and
the action selected in the step (b) is a change in the output of the power source of the pump resulting from a change in a parameter of the first PID controller.

14. The method for controlling the extrusion molding apparatus according to claim 11,
wherein the extruder comprises:
a cylinder; and
a screw housed in the cylinder, the screw being configured to extrude a resin material supplied into the cylinder while kneading the resin material,
wherein the control unit, after fixing the output of the power source of the pump based on a result of the control of the rotation speed of the pump, performs feedback control for the rotation speed of the screw so as to bring the pressure measured by the pressure sensor closer to the target pressure, and
wherein the method further comprises, when feedback control is performed for the rotation speed of the screw, the steps of:
(e) determining, by the control unit, a current state and a reward for an action ac selected in the past based on a difference between the measured pressure and the target pressure;
(f) updating, by the control unit, a control condition based on the reward and selecting an optimum action corresponding to the current state under the updated control condition, the control condition being a combination of a state and an action; and
(g) controlling, by the control unit, the rotation speed of the screw based on the optimum action.

15. The method for controlling the extrusion molding apparatus according to claim 14, wherein the action selected in the step (f) is a change in an output of a power source of the screw.

16. The method for controlling the extrusion molding apparatus according to claim 15, wherein
the control unit comprises a second PID controller configured to control the output of the power source of the screw, and
the action selected in the step (f) is a change in the output of the power source of the screw resulting from a change in a parameter of the second PID controller.

17. A method for controlling an extrusion molding apparatus,
the extrusion molding apparatus comprising:
an extruder comprising: a cylinder; and a screw housed in the cylinder, the extruder being configured to heat and thus melt a resin material supplied into the cylinder, and extrude the molten resin material while kneading the molten resin material by the screw;
a pump configured to suck in the molten resin extruded from the extruder, and discharge the sucked-in molten resin;
a pressure sensor configured to measure a pressure of the molten resin on a suction side of the pump; and
a control unit configured to perform feedback control for a rotation speed of the screw so as to bring the pressure measured by the pressure sensor closer to a target pressure,
the method comprising the steps of:
(e) determining, by the control unit, a current state and a reward for an action selected in the past based on a difference between the measured pressure and the target pressure; and
(f) updating, by the control unit, a control condition based on the reward and selecting an optimum action corresponding to the current state under the updated control condition, the control condition being a combination of a state and an action; and
(g) controlling, by the control unit, the rotation speed of the screw based on the optimum action.

18. The method for controlling the extrusion molding apparatus according to claim 17, wherein the action selected in the step (f) is a change in an output of a power source of the screw.

19. The method for controlling the extrusion molding apparatus according to claim 18, wherein
the control unit comprises a PID controller configured to control the output of the power source of the screw, and
the action selected in the step (f) is a change in the output of the power source of the screw resulting from a change in a parameter of the PID controller.

20. The method for controlling the extrusion molding apparatus according to claim 11, wherein the pump is a gear pump.
